(19) United States
(12) Patent Application Publication
(10) Pub. No.: US 2005/0123692 A1
(43) Pub. Date: Jun. 9, 2005

(54) Method and apparatus for carrying out chemical vapor deposition

(75) Inventor: Scott Grimshaw, Marcellus, NY (US)

Correspondence Address: BURR & BROWN, PO BOX 7068, SYRACUSE, NY, 13261-7068, US

(73) Assignee: Tangidyne Corporation, Skaneateles, NY (US)

(21) Appl. No.: 11/005,200

(22) Filed: Dec. 6, 2004

Related U.S. Application Data
(60) Provisional application No. 60/526,834, filed on Dec. 4, 2003.

(51) Int. Cl. B05D 3/00

(52) U.S. Cl. 427/553

(57) ABSTRACT

A method of depositing a material on a substrate comprises subjecting a substrate to microwaves having a plurality of frequencies in order to heat at least a portion of the substrate to a first temperature, and passing over the substrate a first gas. At least a portion of the first gas breaks down into at least a first component and a second component when subjected to the first temperature, whereby at least a portion of at least the first component is deposited on the substrate. A system for depositing a material on a substrate comprises a microwave chamber, a variable frequency microwave generator (and/or a plurality of microwave generators) which directs into the chamber microwaves of a plurality of frequencies, a substrate and a piezoelectric element positioned within the chamber.

### CROSS-REFERENCE TO RELATED APPLICATIONS

This application claims the benefit of U.S. Provisional Patent Application No. 60/526,834, filed Dec. 4, 2003, the entirety of which is incorporated herein by reference.

### FIELD OF THE INVENTION

The present invention relates to a method for carrying out chemical vapor deposition, and to apparatus for use in carrying out such a method.

### BACKGROUND OF THE INVENTION

Chemical vapor deposition (“CVD”) is used for a variety of purposes. In general, as is well known in the art, CVD is carried out by providing a heated substrate (or object to be coated) in a space in which temperature and pressure conditions are controlled, and a pyrolyzable gas is passed over the substrate. The pyrolyzable gas is selected so as to contain one or more elements or compounds which are desired to be coated on the substrate. The substrate is heated to a temperature at which the pyrolyzable gas is unstable and breaks down, and one or more of the elements and/or compounds in the pyrolyzable gas is deposited on the substrate, thereby forming a thin layer on the substrate. Volatile remnants of the gas are pumped away.

CVD processes are generally carried out within a furnace in which there is provided a very uniform, isothermal environment in which the pyrolyzable gas breaks down. As one example of a CVD process, a silicon layer can be deposited on a wafer by positioning the wafer in a CVD furnace, heating the furnace to bring the wafer to a temperature at which silane (SiH₄) gas pyrolyzes, and passing silane gas through the furnace, whereby the silane gas breaks down and a film silicon is coated on the wafer.

Such CVD processes typically result in hot or cold spots on the object to be coated, which usually leads to undesirable variations in the thickness to which the material is coated. In addition, large amounts of energy are used to maintain the high temperature within the CVD furnace, as well as to heat up the furnace on occasions where it has been shut down. In addition, heating up and cooling down a CVD furnace generally each take a significant amount of time, decreasing productivity.

There is an ongoing need to provide a way to more efficiently carry out CVD processes. In addition, there is an ongoing need to provide a way to carry out CVD processes which result in coatings of better quality and uniformity.

### BRIEF SUMMARY OF THE INVENTION

In accordance with the present invention, there is provided a method of depositing a material on a substrate, comprising:
subjecting a substrate to microwaves having a plurality of frequencies in order to heat the substrate to a first temperature;
passing over the substrate a first gas, at least a portion of the first gas being of a nature that it breaks down into at least a first component and a second component when subjected to the first temperature (or higher), whereby at least a portion of at least the first component is deposited on the substrate.

Preferably, the method further comprises monitoring the thickness of the first component deposited on the substrate. Preferably, such monitoring is carried out by analyzing resonance frequencies of vibration of a piezoelectric element on which at least the first component is deposited simultaneously with the depositing of the first component on the substrate. A particularly preferred piezoelectric element comprises gallium phosphate.

The microwaves having a plurality of frequencies are preferably generated by a variable frequency microwave generator. Variable frequency microwave generators are well known in the art. Variable frequency microwave generators typically employ a series of bursts of a range of microwave frequencies. Alternatively or additionally, two or more microwave generators can be used to produce microwaves having a plurality of frequencies.

By heating the substrate with microwaves having a plurality of frequencies, hot and cold spots caused by the nodes or the microwaves, and/or high and low energy points of the standing wave pattern that forms in the oven, are significantly reduced or even eliminated. Moreover, providing uniform temperature in a substrate is generally more difficult to achieve with larger wafers (the size of the largest wafers have been generally increasing, e.g., there are currently wafers which are as large as 12 inches across), and the present invention can achieve high temperature uniformity even with large wafers.

Use of microwaves having a plurality of frequencies to heat the substrate also allows for rapid heating of the substrates (e.g., on the order of several minutes) and also for rapid cool-down (likewise on the order of several minutes). This allows rapid processing of materials such as silicon wafers. Further, conventional CVD processes also tend to create undesirable overcoating of material onto furnace walls, fittings, etc. that also are hot and which cause the chemical vapor to break down and deposit thereon. Microwave heating in accordance with the present invention can be largely limited to heating the substrate and not the supporting structures or surrounding chamber, resulting in far less maintenance and a lower potential for contamination. In addition, the microwave system according to the present invention can be turned on and off rapidly, thereby reducing energy consumption (as opposed to conventional CVD furnaces, which are often kept at deposition temperatures 24 hours a day in order to avoid lengthy heat-up delays). A further advantage which can be obtained by the present invention is that each substrate in a series being treated can be heated to approximately the same temperature (e.g., to within about 1° C. to about 5° C.).

There is also provided a system for depositing a material on a substrate, comprising a microwave chamber, a variable frequency microwave generator (and/or a plurality of microwave generators) which directs into the chamber microwaves of a plurality of frequencies, a substrate positioned within the chamber and a piezoelectric element positioned within the chamber.

The invention may be more fully understood with reference to the accompanying drawings and the following detailed description of the invention.

### BRIEF DESCRIPTION OF THE DRAWING FIGURES

FIG. 1 is a schematic drawing depicting a first embodiment according to the present invention.

FIG. 2 is a schematic drawing depicting a second embodiment according to the present invention.

### DETAILED DESCRIPTION OF THE INVENTION

As noted above, microwaves having a plurality of frequencies are preferably generated by a variable frequency microwave generator. Representative examples of variable frequency microwave generators which are known in the art include those disclosed in U.S. Pat. Nos. 6,515,040, 6,497,786, 6,457,506, 6,348,516, 6,312,548, 6,268,596, 6,268,200, 6,222,170, 6,172,321, 6,103,812, 6,077,478, 6,054,012, 6,034,346, 5,961,871, 5,892,198, 5,879,756, 5,844,216, 5,841,237, 5,804,801, 5,798,395, 5,772,701, 5,750,968, 5,738,915, 5,721,286, 5,648,038, 5,644,837, 5,521,360 and 5,321,222, the entireties of each of which are hereby expressly incorporated by reference. Typical examples of ranges of frequencies of the microwaves employed by variable frequency microwave generators include, e.g., from about 2 GHz to about 8 GHz, from about 6.5 GHz to about 18 GHz (or an overall range of from about 2 GHz to about 18 GHz).

Preferably, the substrate comprises a wafer. The substrate can be a single base layer or can include a base layer and one or more additional layers deposited thereon. Thus, the substrate can comprise a plurality of laminated layers.

Preferably, there is provided a chamber within which the substrate is placed or moved and subjected to microwaves which are directed into the chamber in accordance with the present invention. The present method can be a batch process, a continuous process or a hybrid (i.e., one or more substrates can be loaded into the chamber and processed, then removed, and then a fresh one or more substrates can be loaded into the chamber; a series of substrates can be moved continuously through the region where they are subjected to the microwaves; or a series of substrates can be moved intermittently such that each substrate (or group of substrates) moves into a region where it is subjected to microwaves and is then moved out of that region and replaced by the next substrate or substrates.

The substrate can be subjected to microwaves for whatever length of time desired in order to achieve the deposition sought. As a result of the advantages provided by the present invention, this time-duration can be significantly reduced in comparison with conventional CVD methods, e.g., to a duration of not more than a minute or two minutes.

The substrate can be heated to generally whatever temperature is required (usually between 100° C. and 1,000° C.) in order to achieve the desired result for the deposition gas being employed. For example, the substrate can be heated to at least about 700° C., at least about 500° C., at least about 300° C., etc. In general, if higher temperatures are needed and/or if larger substrates are being treated, the power fed to the microwave generator can be increased.

In accordance with a preferred aspect of the present invention, the thickness of the first component (or two or more components) is monitored. For example, while the first component is being deposited on the substrate, the thickness of the coating being formed by the first component can be detected, and/or the rate of growth of the thickness of the coating can be detected. Similarly, the thickness of the coating can be detected after the depositing is completed. In a further preferred aspect of the present invention, the thickness monitoring can be carried out using a microbalance, i.e., by analyzing resonance frequencies of vibration of a piezoelectric element on which the first component is deposited simultaneously with the depositing of the first component on the substrate. Suitable microbalances are well known in the art, e.g., as disclosed in U.S. patent application Ser. Nos. 10/460,971 and 10/971,200, the entireties of which are hereby expressly incorporated herein by reference. A particularly suitable microbalance is one in which the vibrating piezoelectric element comprises gallium phosphate (GaPO₄), which, as is well known in the art, provides effective measurements even at elevated temperatures.

As noted above, the present invention also relates to a system for depositing material on a substrate, comprising a microwave chamber, a variable frequency microwave generator (and/or a plurality of microwave generators) which directs into said chamber microwaves of a plurality of frequencies, and a piezoelectric element positioned within said chamber.

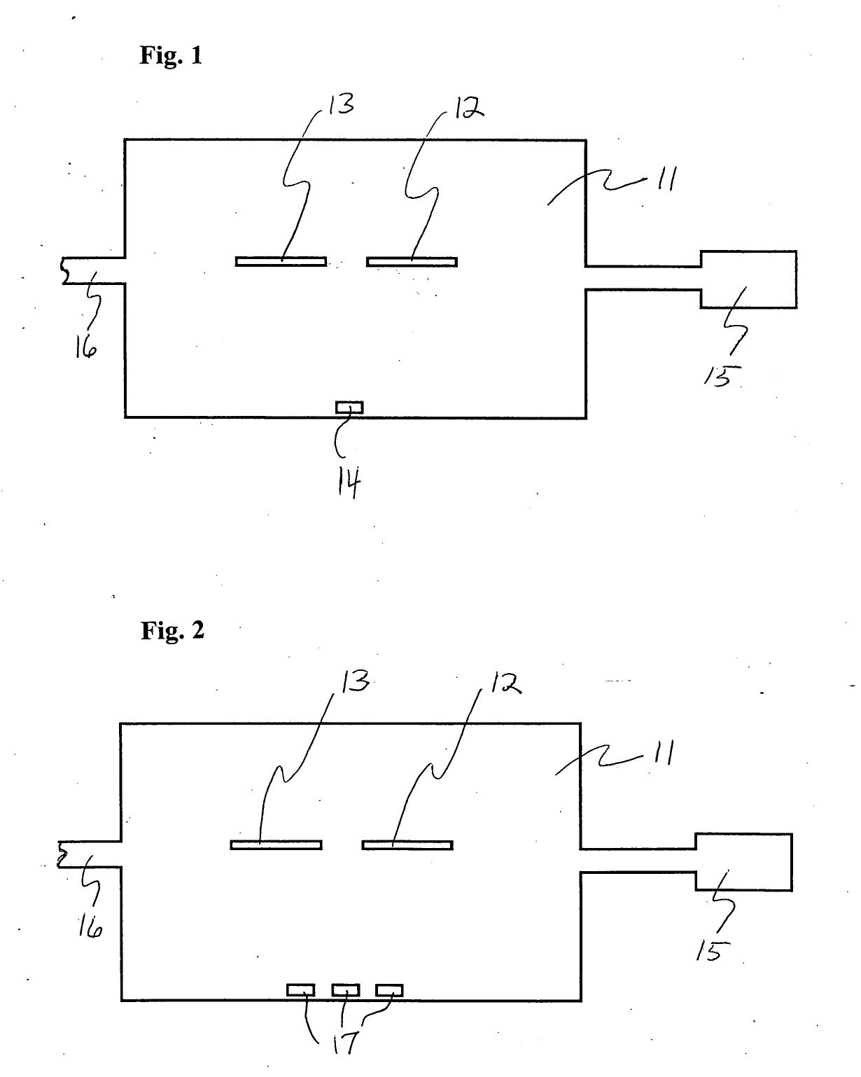

FIG. 1 is a schematic drawing depicting a first embodiment of a system for depositing material on a substrate according to the present invention. Referring to FIG. 1, the system comprises a chamber 11, within which are positioned a substrate 12, a microbalance 13 and a variable frequency microwave generator 14. In operation, a pyrolyzable gas is fed to the chamber 11 from a source of gas 15. The substrate 12 and the microbalance 13 are heated by microwaves from the variable frequency microwave generator 14 (the microwaves having a plurality of frequencies), whereby at least a portion of the pyrolyzable gas breaks down into at least a first component and a second component, and at least a portion of at least the first component is deposited on the substrate and on the microbalance. The remainder of the gas then exits the chamber 11 through the exhaust 16.

FIG. 2 is a schematic drawing depicting a second embodiment of a system for depositing material on a substrate according to the present invention. The system of the embodiment depicted in FIG. 2 is similar to the system of the embodiment depicted in FIG. 1, except that in the embodiment depicted in FIG. 2, three microwave generators 17 are positioned in the chamber 11 instead of the variable frequency microwave generator 14. The operation of the embodiment depicted in FIG. 2 is similar to that of the embodiment depicted in FIG. 1, except that in the embodiment depicted in FIG. 2, each of the microwave generators 17 generate microwaves of substantially a single frequency, the frequencies of the microwaves from the respective microwave generators 17 being different.

Any two or more structural parts of the systems described above can be integrated. Any structural part of the systems described above can be provided in two or more parts (which can be held together, if desired or necessary). Similarly, any two or more functions can be conducted simultaneously, and/or any function can be conducted in a series of steps.

1. A method of depositing a material on a substrate, comprising:
subjecting a substrate to microwaves having a plurality of frequencies in order to heat at least a portion of said substrate to a first temperature;
passing over said substrate a first gas, at least a portion of said first gas breaking down into at least a first component and a second component when subjected to said first temperature, whereby at least a portion of at least said first component is deposited on said substrate.

2. A method as recited in claim 1, wherein said substrate comprises a wafer.

3. A method as recited in claim 1, wherein said subjecting said substrate to microwaves is carried out with said substrate positioned within a chamber into which said microwaves are directed.

4. A method as recited in claim 1, wherein said subjecting said substrate to said microwaves is carried out for not more than about 1 minute.

5. A method as recited in claim 1, wherein said subjecting said substrate to said microwaves is carried out for not more than about 2 minutes.

6. A method as recited in claim 1, wherein said first temperature is at least about 700° C.

7. A method as recited in claim 1, wherein said first temperature is at least about 500° C.

8. A method as recited in claim 1, wherein said first temperature is at least about 300° C.

9. A method as recited in claim 1, wherein said substrate comprises a plurality of laminated layers.

10. A method as recited in claim 1, further comprising monitoring a thickness of at least said first component deposited on said substrate.

11. A method as recited in claim 10, wherein said monitoring is carried out by analyzing resonance frequencies of vibration of a piezoelectric element on which at least said first component is deposited simultaneously with said depositing of at least said first component on said substrate.

12. A method as recited in claim 11, wherein said piezoelectric element comprises gallium phosphate.

13. A method as recited in claim 1, wherein said plurality of frequencies are within a range of from about 2 GHz to about 8 GHz.

14. A method as recited in claim 1, wherein said plurality of frequencies are within a range of from about 6.5 GHz to about 18 GHz.

15. A system for depositing a material on a substrate, comprising:
a microwave chamber;
a variable frequency microwave generator which directs into said chamber microwaves of a plurality of frequencies;
a substrate positioned within said chamber; and
a piezoelectric element positioned within said chamber.

16. A system as recited in claim 15, wherein said piezoelectric element comprises gallium phosphate.

17. A system as recited in claim 15, further comprising at least one source of pyrolyzable gas which feeds said pyrolyzable gas into said chamber.

18. A system for depositing a material on a substrate, comprising:
a microwave chamber;
at least two microwave generators which direct into said chamber microwaves of a plurality of frequencies;
a substrate positioned within said chamber; and
a piezoelectric element positioned within said chamber.

19. A system as recited in claim 18, wherein said piezoelectric element comprises gallium phosphate.

20. A system as recited in claim 18, further comprising at least one source of pyrolyzable gas which feeds said pyrolyzable gas into said chamber.
